(19) United States
(12) Patent Application Publication
(10) Pub. No.: US 2005/0273780 A1
(43) Pub. Date: Dec. 8, 2005

(54) System, device, method and computer code product for partially sharing digital media

(75) Inventor: Marko Torvinen, Espoo (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/846,311

(22) Filed: May 14, 2004

(51) Int. Cl. G06F 9/44

(52) U.S. Cl. 717/171; 717/170

(57) ABSTRACT

A method, device, system, and computer code product provide shared applications for mobile terminals operating in a communication network. The system includes a first mobile terminal and a second mobile terminal in communication with the first mobile terminal. The method comprises configuring a first version of an application for execution on the first mobile terminal, connecting the first mobile terminal to the second mobile terminal, transferring a second version of the application to the second mobile terminal using the connection, and limiting an execution of the second version of the application. In an alternative embodiment, the method comprises initiating execution of an application at a first mobile terminal, connecting the first mobile terminal With a second mobile terminal, sending a view of the executing application from the first mobile terminal to the second mobile terminal, and receiving the view of the executing application from the first mobile terminal at the second mobile terminal.

### FIELD OF THE INVENTION

The present invention relates to systems and methods for distributing software applications. More particularly, the present invention relates to a system and a method for distributing software applications while maintaining control of the distributed software. More specifically, the present invention relates to the distribution and the control of software applications across mobile terminals.

### BACKGROUND OF THE INVENTION

Shareware distribution gives users a chance to try software before buying it. When a user accesses and continues to use a Shareware program, the user is expected to register the program after a reasonable evaluation period. Individual programs differ on details—some request registration while others require it, while still others specify a maximum trial period after which the program no longer executes. By registering the program, a user may obtain anything from the right to continue using the software to an updated program with a printed user's manual. Copyright laws apply to both Shareware and commercial software, and the copyright holder retains all rights. Shareware is a distribution method, not a type of software. With the growth of the Internet, many large commercial software publishers release “trial” versions of their products for download and personal use. These “trial” versions are usually limited in some fashion, for example, the trial software may only execute for a specified length of time or have a limited set of features relative to the commercially purchased version.

Digital Rights Management (“DRM”) is a term used to describe a range of techniques that use information about rights and rights holders to manage copyrighted material and the terms and conditions on which the material is made available to users. More specifically, DRM involves the description, layering, analysis, valuation, trading, and monitoring of an owner's property rights to an asset. DRM covers the management of the digital rights to the physical manifestation of a work (e.g., a textbook) or the digital manifestation of a work (e.g., a Web page). DRM also covers the management of an asset whether the asset has a tangible or an intangible value. Current DRM technologies include languages for describing the terms and conditions for an asset, tracking asset usage by enforcing controlled environments or encoded asset manifestations, and closed architectures for the overall management of the digital rights.

In general, DRM protection is based on the principle that every end-entity able to consume DRM protected content is equipped with a cryptographic key that is usually unique for every end-entity. DRM protected content is distributed, possibly together with a set of consumption rights, in encrypted form. Thus, only authorized parties, usually those that have paid for the content, are able to consume the content. This is done, for example, by encrypting the content with the public key matching the recipient's private DRM key (asymmetric key encryption). For practical reasons, usually a hybrid scheme is chosen, wherein DRM protected content is encrypted under a content encryption key (CEK) using symmetric encryption. The CEK in turn is then encrypted with the public DRM key matching the recipient's private DRM key. The CEK may be accompanied by consumption rights (which may also be encrypted) expressing the usage rules for the DRM protected content. In both approaches only authorized parties are able to consume the DRM protected content assuming secure and correct implementation. The two approaches, however, also share a drawback originating from the fact that every end-entity is equipped with a unique DRM key: content (or the CEK) has to be personalized for every device prior to consumption.

Usually, DRM content is protected, i.e., encrypted, (and therefore personalized) by the network side for various reasons, e.g., to guarantee payment for the content. Typically, the network infrastructure has a server for personalizing content transported in the wireless network. The network centric nature of current approaches, however, is not very suitable for certain types of content, e.g., free content. The most prominent example being content intended for preview or “trial” purposes. Accordingly, it is usually the case that the transfer of purchased, DRM-protected content from one terminal to another cannot be performed by the end user of a terminal.

Typically, the rights holders for content want to enforce certain usage rights over content management, and this includes, in most cases, control over how content can be copied and which technical and security requirements have to be met. DRM version 1.0 from the Open Mobile Alliance (OMA) is an industry-wide standard that allows developers and publishers to protect the intellectual property value of applications and content provided to mobile devices. The OMA DRM version 1.0 standards provide three DRM methods to enable secure mobile content delivery: forward lock, combined delivery, and separate delivery. “Forward lock” restricts a user from forwarding content that the user has received to other mobile terminals. Using “forward lock,” the plaintext content is packaged inside a DRM message that is delivered to the terminal. The device is allowed to play, display, or execute the content, but it cannot forward the object. “Combined delivery” includes content usage rules that restrict user access to the digital media wherein the usage rules are embedded in the digital media. “Combined delivery” prevents peer-to-peer distribution and also controls the content usage. In the combined delivery method, the DRM message contains two objects, the content and a rights object. The rights object defines permissions and constraints for the use of content. These can, for example provide permission to use the content only for 10 days or to play a music file only once. Neither the content nor the rights object can be forwarded from the target device. This differs from Shareware which also embeds the rights within the content because Shareware can be forwarded to another target device.

The purpose of “Separate Delivery” is to protect higher value content. It enables super-distribution which allows the device to forward the content, but not the usage rights. This is achieved by delivering the content and usage rights using separate channels. “Super-distribution” allows for content to be wrapped and rights to be ascribed to the use of that content as it travels over the Web. The content is encrypted into DRM Content Format (DCF) using symmetric encryption; the DCF provides plaintext headers describing content type, encryption algorithm, and other useful information. The rights object holds the symmetric CEK that is used by the DRM User Agent in the device for decryption. The rights object is created by using the OMA Rights Expression Language. Recipients of super-distribution enabled content must contact the content retailer to obtain rights to either preview or purchase the media. Thus, the separate delivery method enables viral distribution of media maximizing the number of potential customers while retaining control for the content provider through centralized rights acquisition.

The patent application publication Serial No. 2002/0184156 provides a method and apparatus for facilitating the transfer of usage rights for digital content. The system comprises digital content, a usage rights module containing usage rights information associated with the content for a user, a transfer permission module containing transfer permission information for the content, a current user identification module containing identity information indicating the identity of the user, and means for manipulating the current user identification module to change the identity information. Payment for the work is passed from user or to distributor by way of a clearinghouse that collects requests from the user and distributor and from other users who wish to use particular content. The clearinghouse collects payment information, such as debit transactions, credit card transactions, or other known electronic payment schemes.

International Publication Number WO 03/034653, assigned to the assignee of the present invention, provides a method and apparatus for the super-distribution of content on a network having a plurality of terminals. The network includes various terminals including desktop computers, mobile communication devices, and intelligent home appliances all of which have connectivity to a common network. A super-distribution federation model that integrates DRM technology with the Short Messaging Service (SMS) facilities of a cellular network is provided. The user of a terminal can forward content to another terminal so that the other user can inspect and purchase the content if desired.

Games are an exciting way to communicate and to connect with a large community of like minded people. Rich mobile games, combined with connected local area multiplayer gaming over Bluetooth and wide area multiplayer gaming using cellular networks, open the door for completely new gaming concepts. Developers are providing mobile terminals that support mobile game decks combined with mobile communication devices that use short range, local wireless networks supported by the Bluetooth wireless technology as well as the long range, wide area wireless networks provided by cellular networks. Thus, in addition to providing communications, mobile terminals also feature applications for providing gaming, digital music players, e-mail, and other Java based applications. Currently, these applications are provided separately to each mobile terminal generally on memory cards using the Multi-Media Card (MMC) standard. This method utilizes the traditional distribution method for digital media wherein to access the application, each user must separately purchase the application.

Multiplayer games and some other applications, however, require more than inspection of the content. To encourage purchase of a multiplayer game, users should be able to play the game for at least some period of time or on some number of occasions before purchase of the game is required. Thus, there is a need for systems and methods that permit users to utilize applications while flexibly restricting the further distribution of the application. Further, there is a need for systems and methods that provide protected content while making it easier to start multi-player gaming sessions.

### SUMMARY OF THE INVENTION

The present invention is directed to a system, device, and method of partially sharing digital media between mobile terminals. Briefly, one exemplary embodiment relates to a method of providing shared applications for mobile terminals, the method comprising configuring a first version of an application for execution on a first mobile terminal, connecting the first mobile terminal to a second mobile terminal, transferring a second version of the application to a second mobile terminal using the connection, and limiting an execution of the second version of the application.

Another exemplary embodiment relates to a method of providing shared applications for mobile terminals, the method comprising configuring an application for execution on a first mobile terminal, initiating execution of the application at the first mobile terminal, connecting the first mobile terminal with a second mobile terminal, sending a view of the executing application from the first mobile terminal to the second mobile terminal, and receiving the view of the executing application from the first mobile terminal at the second mobile terminal.

Yet another exemplary embodiment relates to a computer program product computer code configured to connect a first mobile terminal to a second mobile terminal, to transfer a second version of the computer code to the second mobile terminal using the connection, and to limit an execution of the second version of the computer code.

Yet another exemplary embodiment relates to a computer program product computer code configured to connect a first mobile terminal to a second mobile terminal, to create a view at the first mobile terminal, to send the view created from the first mobile terminal to the second mobile terminal, to receive control information from the second mobile terminal, and to respond to the control information received from the second mobile terminal.

Yet another exemplary embodiment relates to a system for providing shared applications for mobile terminals, the system comprising a first mobile terminal executing an application, and a second mobile terminal wherein the first mobile terminal connects to the second mobile terminal, transfers a second version of the application to the second mobile terminal, and limits an execution of the second version of the application.

Yet another exemplary embodiment relates to a system for providing shared applications for mobile terminals, the system comprising a first mobile terminal executing an application that creates a view, and a second mobile terminal wherein the first mobile terminal connects to the second mobile terminal and sends the view of the application to the second mobile terminal, and further wherein the second mobile terminal receives the view of the application and sends control information for the application to the first mobile terminal.

Yet another exemplary embodiment relates to a device configured to provide shared applications for mobile terminals operating in a communication network, the device comprising a communication interface that connects the device to a second device, and a processor coupled to the communication interface that executes an application, wherein the communication interface transfers a second version of the application to the second device, and the processor limits an execution of the second version of the application.

Yet another exemplary embodiment relates to a device configured to provide shared applications for mobile terminals operating in a communication network, the device comprising a communication interface that connects the device to a second device, and a processor coupled to the communication interface that transfers a view of the application to the second device, receives control information for the application from the second device, and responds to the control information received from the second device.

Other principle features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a diagrammatic representation of a communication system in accordance with an exemplary embodiment.

FIG. 2 is a diagrammatic representation of a mobile communication device in the system of FIG. 1 in accordance with an exemplary embodiment.

FIG. 3 is a flow diagram depicting operations in a communication system with partial sharing of an application in accordance with an exemplary embodiment.

FIG. 4 is a flow diagram depicting operations in a communication system with sharing of an application based on allowing a threshold number of executions of the application at a second terminal in accordance with an exemplary embodiment.

FIG. 5 is a flow diagram depicting operations in a communication system with sharing of an application based on allowing a threshold usage time for the application at a second terminal in accordance with an exemplary embodiment.

FIG. 6 is a flow diagram depicting operations in a communication system with sharing of an application based on allowing a threshold number of executions of the application at a second terminal wherein the counter is maintained at a network server in accordance with an exemplary embodiment.

FIG. 7 is a flow diagram depicting operations in a communication system with sharing of an application based on allowing a threshold usage time for the application at a second terminal wherein the time duration of execution is maintained at a network server in accordance with an exemplary embodiment.

FIG. 8 is a flow diagram depicting operations in a communication system with partial sharing of an application in accordance with an alternative exemplary embodiment.

FIG. 9 is a flow diagram depicting operations in a communication system with partial sharing of an application based on allowing a threshold number of executions of the application at a second terminal wherein the counter is maintained at a first terminal in accordance with an alternative exemplary embodiment.

FIG. 10 is a flow diagram depicting operations in a communication system with partial sharing of an application based on allowing a threshold usage time for the application at a second terminal wherein the time duration of execution is maintained at a first terminal in accordance with an alternative exemplary embodiment.

FIG. 11 is a flow diagram depicting operations in a communication system with partial sharing of an application in accordance with another alternative exemplary embodiment.

### DETAILED DESCRIPTION OF EXEMPLARY EMBODIMENTS

The term “mobile terminal” should be understood to include cellular telephones; PDAs with telephonic or wireless communication capabilities such as those manufactured by PALM, Inc.; Instant Messaging Devices, such as those manufactured by Blackberry, Inc.; notebook computers with telephonic or wireless communication capabilities; and other mobile devices that can communicate using various transmission technologies (including CDMA, GSM, TDMA, Bluetooth, and others) or media (radio, infrared, laser, and the like). In addition to providing communications, mobile terminals also feature applications for providing gaming, digital music players, e-mail, and other Java based applications

The term “execution” is the process of running a program or the carrying out of the operation called for by an instruction. A computer processor executes an instruction, meaning that it performs the operations called for by that instruction.

Connecting a mobile terminal to another mobile terminal may be through one or more of the following connection methods without limitation: a link established according to the Bluetooth Standards and Protocols, an infrared communications link, a wireless communications link, a cellular network link, a physical serial connection, a physical parallel connection, a link established according to the Transmission Control Protocol/Internet Protocol and Standards, etc. Other connection methods may be used. Thus, these connection methods are for illustration and not for purposes of limitation. Transferring content from one mobile terminal to another mobile terminal may be using one or more of these connection types. Transferring may use messaging services provided for mobile communication devices including, but not limited to, the SMS, the Multi-Media Messaging Service (MMS), e-mail, and Instant Messaging (IM). E-mail and/or IM may themselves be based on the SMS and the MMS. SMS for transferring content may be used in exemplary embodiments due to the low overhead of such messages. Other transfer methods, however, may be used.

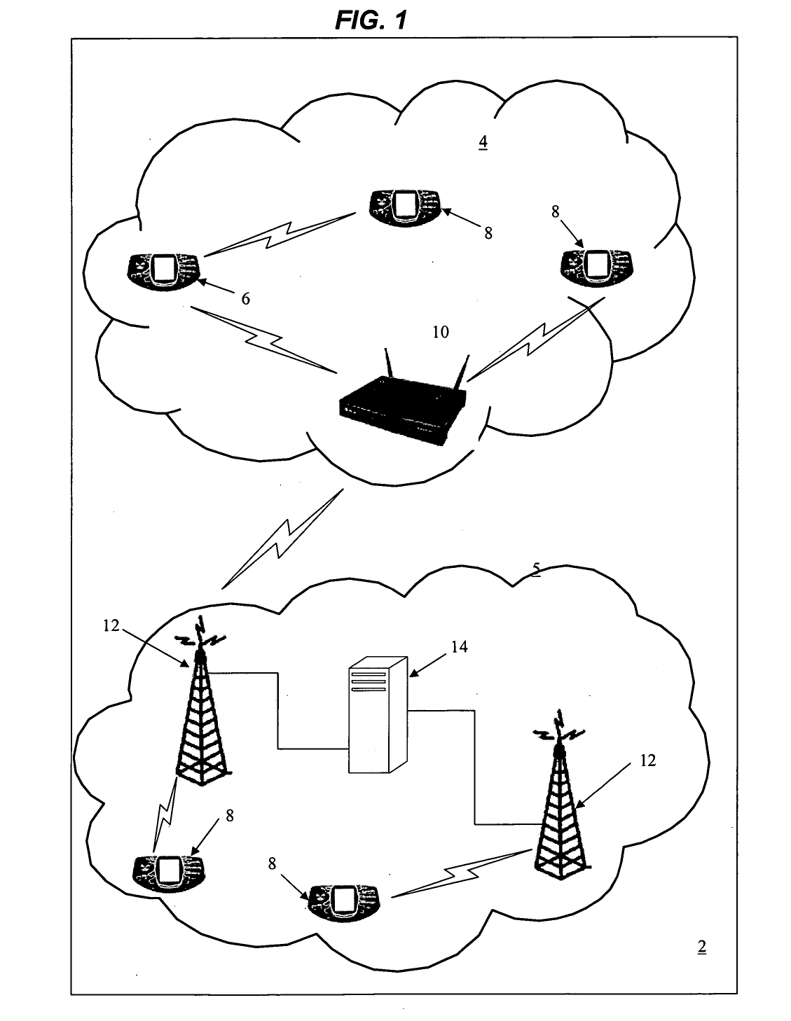

FIG. 1 illustrates a communication system 2 that may include a personal area network 4 and/or a cellular network 5. In an exemplary embodiment, the communication system 2 may include only a personal area network 4 without the need for the cellular network 5. Either or both of the personal area network 4 and the cellular network 5 may include a mobile terminal 6 and other mobile terminals 8. The mobile terminal 6 has an application that may be a game or any other application implementable on the mobile terminal 6. The mobile terminal 6 “shares” the application with other mobile terminals 8 either through the personal area network 4 and/or the cellular network 5. Still other mobile terminals 8 may be connected with the mobile terminal 6 using the Internet (not shown). The mobile terminals 6, 8 may be connected in the personal area network through a wireless router 10 or directly to each other as shown in FIG. 1. In the cellular network 5, the mobile terminals 6 (not shown) and/or 8 are connected to other mobile terminals 8 through a base station 12 that may connect to other base stations 12 through a network server 14. The personal area network 4 and the cellular network 5 are connected through various methods well-known to those skilled in the art. The base station 12 may be a station located proximate the mobile terminal device 6, 8 that provides communication of messages to and from entities comprising the communication system 2.

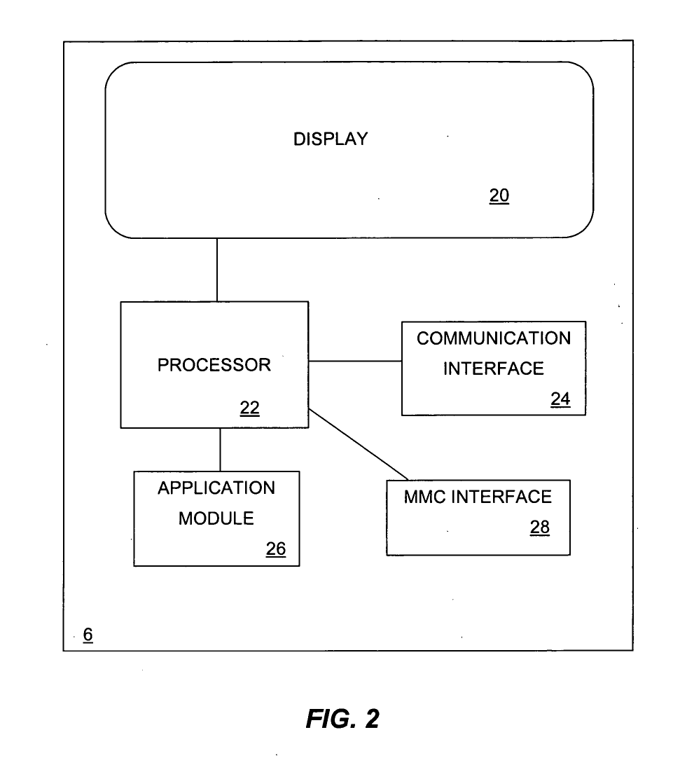

In an exemplary embodiment, the mobile terminal 6, as shown in FIG. 2, has a display 20, a processor 22, a communication interface 24, an application module 26, and a MMC interface 28. The display 20 presents messages for display and for editing and displays a user interface created by executing applications. In an exemplary embodiment, a view of the user interface at an instant in time is captured. The display 20 can be a thin film transistor (TFT) display, a light emitting diode (LED) display, or any of a variety of different displays. The application module 26 can be a computer chip or an arrangement of programmed instructions directing the execution of the application. The programmed instructions may be located on a MMC. The MMC interface 28 provides access to the MMC by the processor 22 for execution of the programmed instruction set stored on the MMC. The processor 22 executes instructions from the application module 26 and instructions contained within the processor 22. The communication interface 24 provides an interface for receiving and transmitting information between the mobile terminals 6, 8 and other network devices including the base station 12.

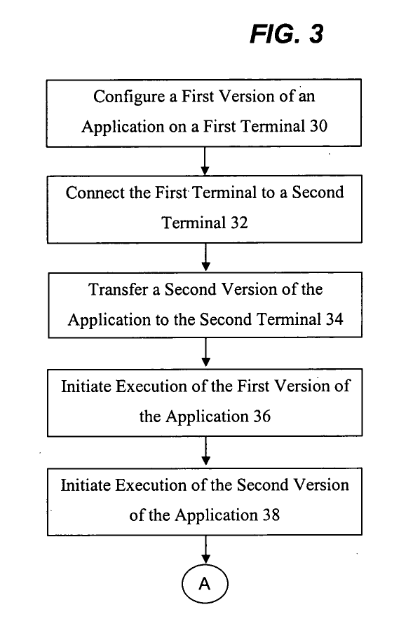

A first user purchases an application for execution on a mobile terminal. The purchase may have been at a traditional store and involve a MMC that plugs into the mobile terminal through the MMC interface 28. Alternatively, the application may have been purchased from a network server 14 or a Web server (not shown) and downloaded to the mobile terminal 6 using a network connection. As shown in FIG. 3 at an operation 30, the application is configured for execution on the mobile terminal 6 (first terminal). Configuration may include installation of the application downloaded from the network. At an operation 32, the user at the first terminal 6 connects to a user at a second terminal 8. After connecting with the second terminal 8, a second version of the application is transferred from the first terminal 6 to the second terminal 8 at an operation 34. In an exemplary embodiment, the transfer of the second version of the application may only occur on the first connection between the first terminal 6 and the second terminal 8. The user at the first terminal 6, at operation 36, initiates execution of the application. The user at the second terminal 8, at operation 38, initiates execution of the second version of the application. Multiple terminals 8 may be connected with first terminal 6 that transfers the second version of the application to each mobile terminal 8. The second version of the application transferred to each mobile terminal 8 also initiates execution of the application at the respective mobile terminal.

Continued processing depends on the operational configuration of the second version of the application. The second version of the application may have the same functionality as the application executing on the first terminal 6. The functionality of an application includes the complete set of capabilities provided by the application separate from the usage rights for that application. The shared application, however, may have reduced functionality. An example of reduced functionality might include an inability to initiate a new game session. Thus, the second version of the application having a reduced functionality may only allow a user to join an already executing multi-player game.

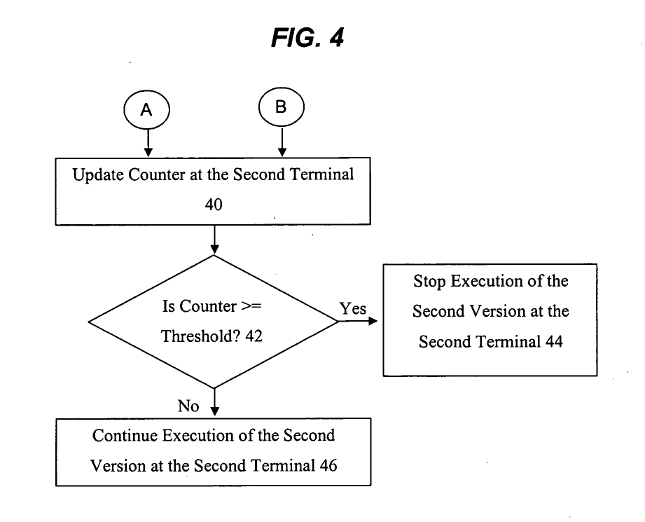

Functionality is distinct from usage rights for the application. The second version of the application may provide the same functionality as the application executing on the first terminal 6, but, for example, only allow execution of the application a predetermined number of times. Usage rights, thus, limit the execution of the second version of the application. In an exemplary embodiment as shown in FIG. 4 at operation 40, a counter value is updated at the second terminal 8 each time the second version of the application is executed at the second terminal 8. A test at operation 42 compares the updated value of the counter to a pre-determined threshold value set in the usage rights associated with the second version of the application to determine whether to continue execution of the second version of the application on the second terminal. For example, in one embodiment, if the counter value is below the threshold, execution of the second version of the application continues at operation 46. If the counter value is above or equal to the threshold, execution of the second version of the application stops at operation 44. The user may no longer execute the second version of the application.

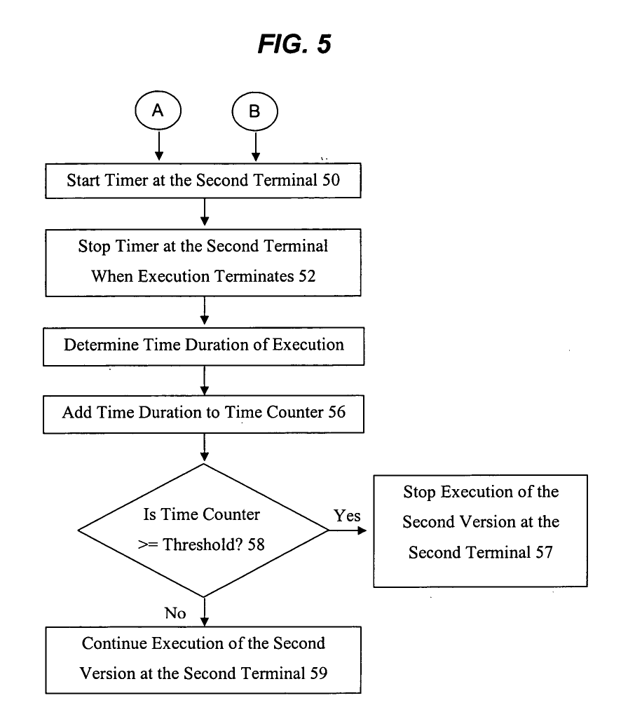

In an alternative embodiment, as shown in FIG. 5, a timer may be used to limit the usage rights of the second user to the second version of the application. At operation 50, a timer is started at the second terminal. When execution of the second version of the application stops at operation 52, the timer also stops. The time duration of the execution of the second version of the application is then determined at operation 54. This time duration is added to the previous value of the time counter at operation 56. A test at operation 58 compares the current value of the time counter to a pre-determined threshold value set in the usage rights associated with the second version of the application to determine whether to continue execution of the second version of the application on the second terminal. For example, in one embodiment of the invention, if the time counter is below the threshold, execution of the second version of the application continues at operation 57. If the time counter is above or equal to the threshold, execution of the second version of the application stops at operation 59. The user may no longer execute the second version of the application.

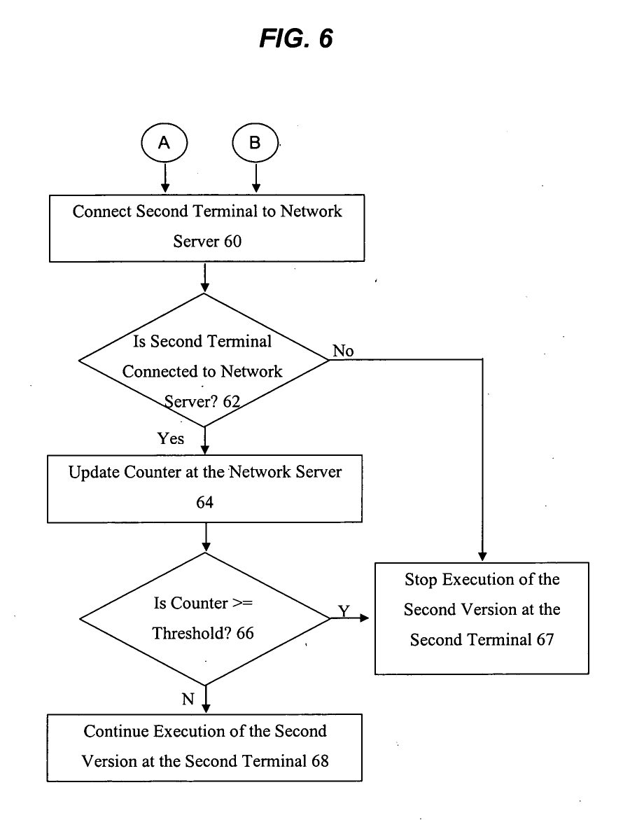

In an alternative embodiment, as shown at operation 60 in FIG. 6, the second terminal 8 may connect to a network server 14 that may be part of the cellular network 5 or connected to the second terminal 8 through the Internet. The second terminal 8 may connect with the first terminal 6 using either of the personal area network 4 or the cellular network 5. Configuration of the usage rights associated with the second version of the application requires a connection to the network server 14 to allow continued execution of the second version of the application at the mobile terminal 8. A test at operation 62 is conducted to determine if the second terminal is connected to the network server. If the second terminal is not connected to the network server, execution of the second version of of the application is stopped at operation 67. If second terminal is connected to the network server, a counter value is updated at operation 64 at the network server 14 each time the second version of the application is executed at the second terminal 8. This may require that the network server maintain a database or text file to track the specific second terminal 8, the application executed (for example, the game executed), and the counter of the executions of that application by the specific second terminal 8. Other methods for maintaining the counter may also be used as is well known to those skilled in the art. For example, the counter may be maintained in a registry and indexed by a mobile terminal identifier and possibly an application identifier. A test at operation 66 compares the current value of the counter maintained at the network server 14 to a pre-determined threshold value set in the usage rights associated with the second version of the application to determine whether to continue execution of the second version of the application. For example, in one embodiment of the invention, if the counter is below the threshold, execution of the second version of the application continues at operation 68. If the counter is above or equal to the threshold, execution of the second version of the application stops at operation 67. The user may no longer execute the second version of the application. The second version of the application may be disabled by the network server 14 using a number of methods including, for example, by sending a stop execution message or by not sending a continue execution message to the second terminal 8. The second version of the application responds to the message by terminating execution.

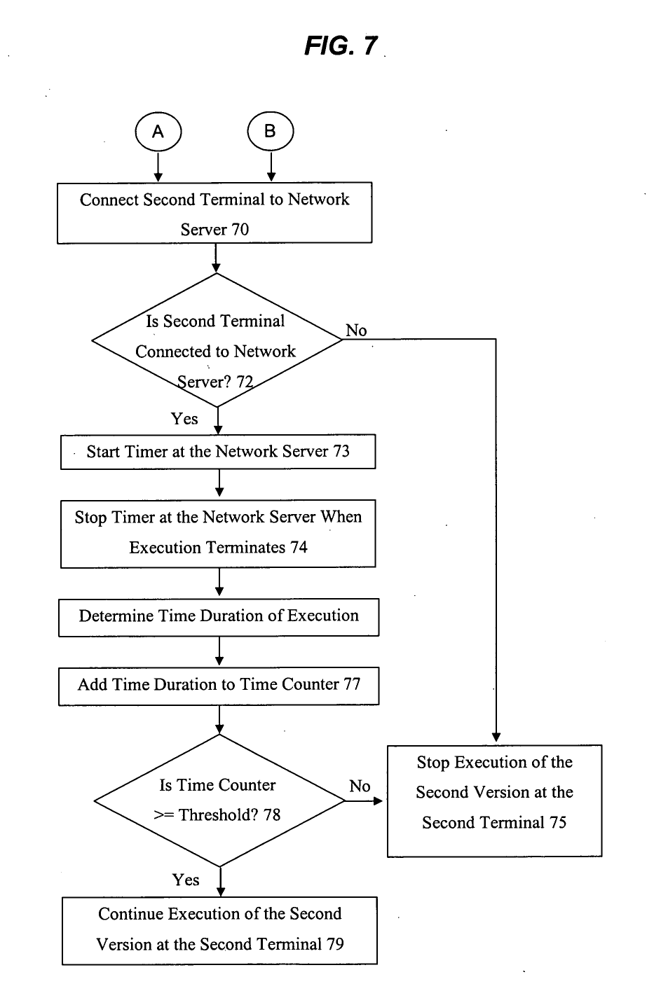

In an alternative embodiment, as shown at operation 70 in FIG. 7, the second terminal 8 may connect to a network server 14 that may be part of the cellular network 5 or connected to the second terminal 8 through the Internet. The second terminal 8 may connect with the first terminal 6 using either of the personal area network 4 or the cellular network 5. Configuration of the usage rights associated with the second version of the application requires a connection to the network server 14 to allow continued execution of the second version of the application at the mobile terminal 8. A test at operation 72 is performed to determine if the second terminal is connected to the network server. If the second terminal is not connected to the second terminal, execution of the second version of the application is stopped at operation 75. If the second terminal is connected to the network server, a timer is started at operation 73 at the network server 14. When execution of the second version of the application stops at operation 74, the timer also stops. The time duration of the execution of the second version of the application is then determined at operation 76 at the network server 14. This time duration is added to the previous value of the time counter maintained at the network server 14 at operation 77. The previous value of the time counter can be saved at the network server 14. This may require that the network server maintain a database or text file to track the specific second terminal 8, the application executed (for example, the game executed), and the time counter for execution of that application by the specific second terminal 8. Other methods for maintaining the counter may also be used as well known to those skilled in the art. For example, the counter may be maintained in a registry and indexed by a mobile terminal identifier and possibly an application identifier. A test performed at the network server 14 at operation 78 compares the current value of the time counter to a pre-determined threshold value set in the usage rights associated with the second version of the application to determine whether to continue execution of the second version of the application. For example, in one embodiment of the invention, if the time counter is below the threshold, execution of the second version of the application continues at operation 79. If the time counter is above or equal to the threshold, execution of the second version of the application stops at operation 75. The user may no longer execute the second version of the application. The second version of the application may be disabled by the network server 14 using a number of methods including, for example, by sending a stop execution message or by not sending a continue execution message to the second terminal 8.

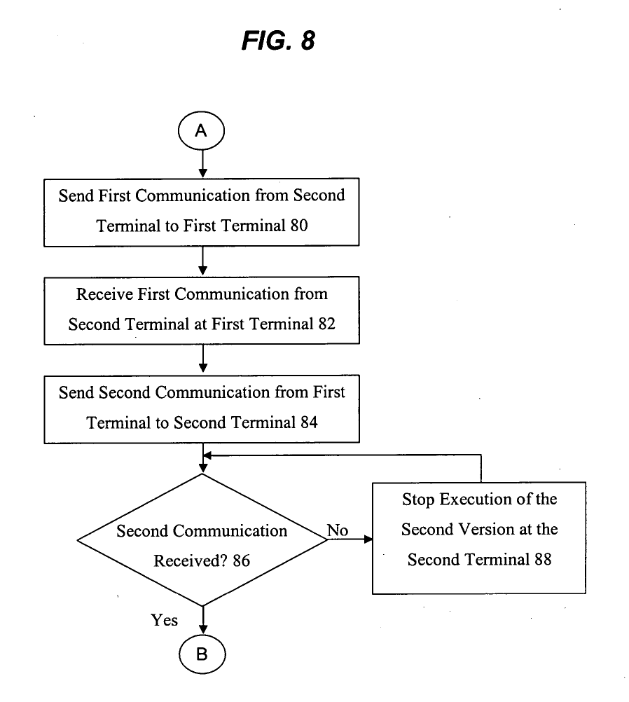

In an alternative embodiment, as shown at operation 80 in FIG. 8, the second terminal 8, after connecting to the first terminal 6, sends a first communication to the first terminal 6 notifying the first terminal of the presence of the second terminal 8. Where the application is a game, for example, the first communication may be a request to join the game. The first terminal 6 receives the first communication at operation 82. The first terminal 6 responds to the first communication by sending a second communication to the second terminal 8 at operation 84. The second communication can be used to determine whether to continue operation of the second version of the application. For example, according to one embodiment of the invention, at the second terminal 8, a test at operation 86 waits to receive the second communication from the first terminal 6. Until the second communication is received at the second terminal 8, execution of the second version is stopped at operation 88.

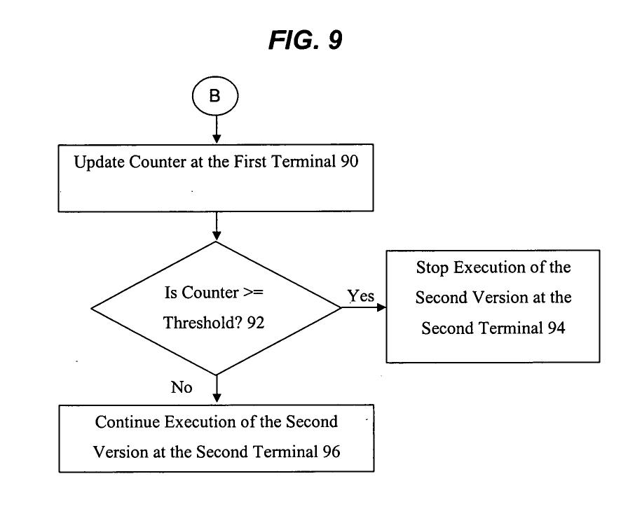

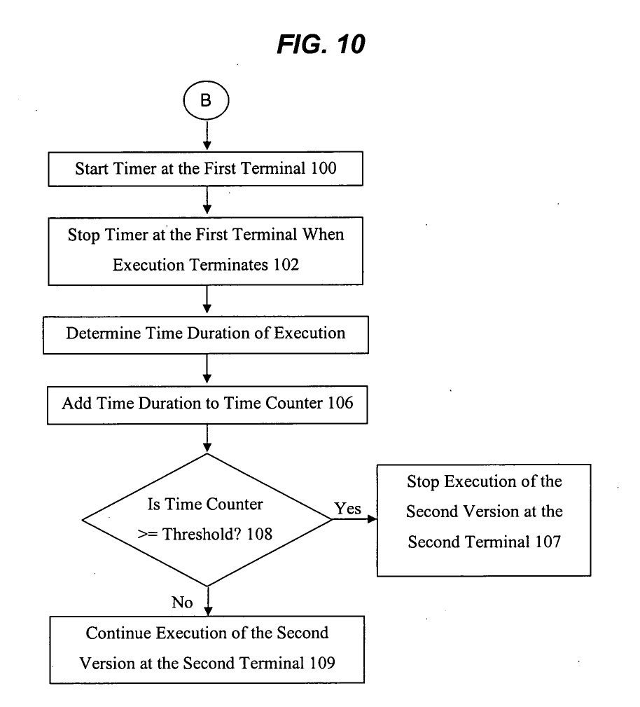

As shown in FIG. 9, after the second communication is received, the operational flow may take one of at least three paths. As already discussed relative to FIGS. 4, 5, 6, and 7, a counter or a time counter may be used to limit the execution of the second version of the application at the second terminal. The counter or time counter may be maintained at the second terminal (FIGS. 4 and 5) or at the network server (FIGS. 6 and 7). Alternatively, as shown in FIGS. 9 and 10, the counter and time counter may be maintained at the first terminal. At operation 90, a counter is updated at the first terminal 6 each time the second version of the application is executed at the second terminal 8. This may require that the first terminal 6 maintain a database or text file to track the specific second terminal 8, the application executed (for example, the game executed), and the counter of the executions of that application by the specific second terminal 8. Other methods for maintaining the counter may also be used as well known to those skilled in the art. For example, the counter may be maintained in a registry and indexed by a mobile terminal identifier and possibly an application identifier. As another alternative, the application may maintain a table of identifiers with a corresponding counter or time counter. A test at operation 92 compares the current value of the counter maintained at the first terminal 6 to a pre-determined threshold value set in the usage rights associated with the second version of the application to determine whether to continue operation of the second version of the application. For example, according to one embodiment of the invention, if the counter is below the threshold, execution of the second version of the application continues at operation 96. If the counter is above or equal to the threshold, execution of the second version of the application stops at operation 94. The user may no longer execute the second version of the application. The second version of the application may be disabled by the first terminal 6 using a number of methods including, for example, by sending a stop execution message or by not sending a continue execution message to the second terminal 8.

In FIG. 10, at operation 100, a timer is started at the first terminal 6. When execution of the second version of the application stops at operation 102, the timer also stops. The time duration of the execution of the second version of the application is then determined at operation 104 at the first terminal 6. This time duration is added to the previous value of the time counter at operation 106. The previous value of the time counter can be saved at the first terminal 6. This may require that the first terminal 6 maintain a database or text file to track the specific second terminal 8, the application executed (for example, the game executed), and the time counter for execution of that application by the specific second terminal 8. Other methods for maintaining the counter may also be used as well known to those skilled in the art. For example, the counter may be maintained in a registry and indexed by a mobile terminal identifier and possibly an application identifier. A test performed at the first terminal 6 at operation 108 compares the current value of the time counter to a pre-determined threshold value set in the usage rights associated with the second version of the application to determine whether to continue execution of the second version of the application. For example, in one embodiment of the invention, if the time counter is below the threshold, execution of the second version of the application continues at operation 109. If the time counter is above or equal to the threshold, execution of the second version of the application stops at operation 107. The user may no longer execute the second version of the application. The second version of the application may be disabled by the first terminal 6 using a number of methods including, for example, by sending a stop execution message or by not sending a continue execution message to the second terminal 8.

In an alternative embodiment, a computer program product is provided and executed by the processor 22. The computer program product provides an application and supports sharing of the application between mobile terminals. The computer program product may include a user interface that is displayed on display 20 of the terminal 6. The computer program product comprises computer code configured to connect a first mobile terminal to a second mobile terminal, transfer a second version of the computer code to the second mobile terminal using the connection, and limit an execution of the second version of the computer code. The execution of the second version of the computer code transferred to the second mobile terminal 8 may be, for example, through any of the methods discussed relative to FIGS. 3-10.

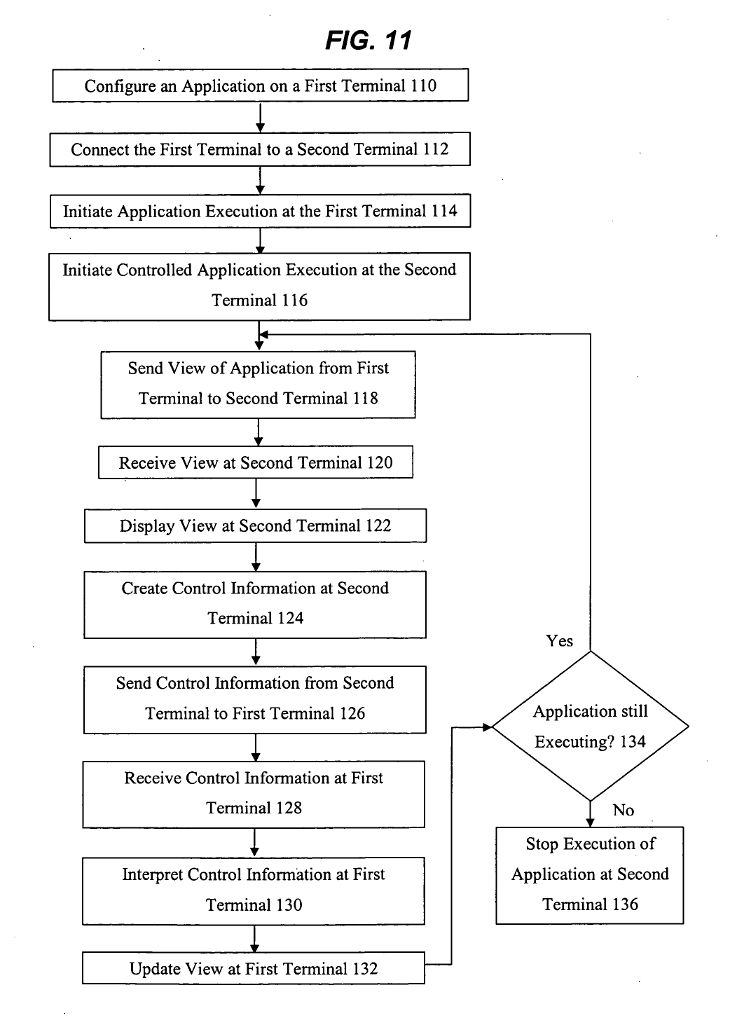

In an alternative exemplary embodiment as shown in FIG. 11 at operation 110, an application is configured for execution on the mobile terminal 6 (first terminal). A first user purchases the application for execution on a mobile terminal. The purchase may have been at a traditional store and involve an MMC that plugs into the mobile terminal through the MMC interface 28. Alternatively, the application may have been purchased from a network server 14 or a Web server (not shown) and downloaded to the mobile terminal 6 using a network connection. Configuration may include installation of the application downloaded from the network. At operation 112, the first terminal 6 connects to the second terminal 8. Execution of the application is initiated at operation 114 on the first terminal 6. At operation 116, execution of a controlled application that includes a public interface is initiated at the second terminal 8. The ability to initiate an execution of the controlled application at the second terminal 8 may be a capability implemented in the terminal 6, 8, for example, through installation of a general application when the terminal 6, 8 is purchased. Without a connection to the application executing on a first terminal 6, the controlled application has no apparent functionality. At operation 118, the first terminal 6 sends a view of the executing application to the second terminal 8. The second terminal 8 receives the view of the executing application at operation 120. The received view is displayed by the controlled application at the second terminal 8 at operation 122. The received view depicts the current status of the executing application at the first terminal 6.

At operation 124, the user of the second terminal 8 responds to the received view by creating control information pertinent to the application executing at the first terminal 6 through the controlled application. Multiple second terminals 8 also may receive the view from the first terminal 6 and create control information in response to receiving the view from the first terminal 6. Control information may include information, for example, indicating movement of a character in a game that is being “played” by the user of the second terminal 8. The control information created at the second terminal 8 is sent to the first terminal 6 at operation 126. The first terminal 6 receives the control information at operation 128. The application executing at the first terminal 6 interprets the control information received from the second terminals 8 at operation 130. The application view, at operation 132, is updated to reflect the control information received from the second terminal 8. At operation 134, a test is performed to determine if the application continues to execute at the first terminal 6. If the application stops executing at the first terminal 6, the controlled application execution at the second terminal 8 stops at operation 136. If the application continues to execute at the first terminal 6, the updated view reflecting the received control information from the second terminals 8 is sent to the second terminals 8 at operation 118. As a result, the exemplary embodiment depicted in FIG. 11 provides a method for sharing an application between terminals that does not require distribution of the application. Each terminal 8 has installed a controlled application that include a public interface with the capability to receive views, to display the views, to create control information pertinent to the views, and to send the control information to the terminal 6 executing the application.

In an alternative exemplary embodiment, a computer program product is provided and executed by the processor 22. The computer program product provides an application and supports sharing of the application controls between mobile terminals. The computer program product may include a user interface that is displayed on display 20 of the terminal 6. The computer program product comprises computer code configured to connect a first mobile terminal to a second mobile terminal, to create a view of the application executing at the first mobile terminal, to send the view created from the first mobile terminal to the second mobile terminal, to receive control information from the second mobile terminal, and to respond to the control information received from the second mobile terminal. The computer code may be further configured to interpret the control information received from the second mobile terminal, to update the view of the application executing at the first mobile terminal with the interpreted control information, and to send the updated view from the first mobile terminal to the second mobile terminal.

In an alternative exemplary embodiment, a computer program product is provided and executed by the processor 22. The computer program product provides a controlled application that displays a view of an application executing at a first terminal 6. The computer program product comprises computer code configured to connect a first mobile terminal to a second mobile terminal, to receive a view of an application executing at the first mobile terminal, to display the view of the executing application received from the first mobile terminal, to create control information for the executing application at the first mobile terminal, and to send the control information to the first mobile terminal.

This detailed description outlines exemplary embodiments of a method, a device, a system, and a computer code product for providing shared applications between mobile terminals. These embodiments control distribution of digital media including applications while allowing sharing of the digital media under controlled circumstances to encourage future purchase of the digital media. In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

While the exemplary embodiments illustrated in the Figures and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims.

1. A method of providing shared applications for mobile terminals, the method comprising:
configuring a first version of an application for execution on a first mobile terminal;
connecting the first mobile terminal to a second mobile terminal;
transferring a second version of the application to a second mobile terminal using the connection; and
limiting an execution of the second version of the application.

2. The method of claim 1, wherein limiting the execution of the second version comprises:
initiating execution of the second version at the second mobile terminal;
updating a counter value at the second mobile terminal when the second version initiates execution;
comparing the updated counter value to a predetermined threshold at the second mobile terminal; and
determining whether to continue execution of the second version at the second mobile terminal based on the comparison between the updated counter value and the predetermined threshold.

3. The method of claim 1, wherein limiting the execution of the second version comprises:
initiating execution of the second version at the second mobile terminal;
starting a timer at the second mobile terminal when execution of the second version initiates;
stopping the timer at the second mobile terminal when execution of the second version ends;
determining a duration time that the second version executed from the timer;
adding the duration time to a time counter at the second mobile terminal;
comparing the time counter to a predetermined threshold at the second mobile terminal; and
determining whether to continue execution of the second version at the second mobile terminal based on the comparison between the time counter and the predetermined threshold.

4. The method of claim 1, wherein limiting the execution of the second version comprises:
connecting the second mobile terminal to a network server;
initiating execution of the second version at the second mobile terminal;
updating a counter value at the network server when the second version initiates execution at the second mobile terminal;
comparing the updated counter value to a predetermined threshold at the network server; and
determining whether to continue execution of the second version at the second mobile terminal based on the comparison between the updated counter value and the predetermined threshold.

5. The method of claim 1, wherein limiting the execution of the second version comprises:
connecting the second mobile terminal to a network server;
initiating execution of the second version at the second mobile terminal;
starting a timer at the network server when execution of the second version initiates;
stopping the timer at the network server when execution of the second version ends;
determining a duration time that the second version executed from the timer;
adding the duration time to a time counter at the network server;
comparing the time counter to a predetermined threshold at the network server; and
determining whether to continue execution of the second version at the second mobile terminal based on the comparison between the time counter and the predetermined threshold.

6. The method of claim 1, wherein limiting the execution of the second version comprises:
initiating execution of the second version at the second mobile terminal;
sending a first communication to the first mobile terminal from the second mobile terminal when execution of the second version initiates;
sending a second communication to the second mobile terminal from the first mobile terminal in response to receiving the first communication at the first mobile terminal; and
determining whether to continue execution of the second version at the second mobile terminal based on the second communication.

7. The method of claim 6, wherein limiting the execution of the second version further comprises:
updating a counter value when the second version initiates execution;
comparing the updated counter value to a predetermined threshold; and
determining whether to continue execution of the second version of the application at the second mobile terminal based on the comparison between the updated counter value and the predetermined threshold.

8. The method of claim 7, wherein the counter is located at the second mobile terminal.

9. The method of claim 7, wherein the counter is located at a network server in communication with the second mobile terminal.

10. The method of claim 7, wherein the counter is located at the first mobile terminal.

11. The method of claim 6, wherein limiting the execution of the second version comprises:
starting a timer when execution of the second version initiates;
stopping the timer when execution of the second version ends;
determining a duration time that the second version executed from the timer;
adding the duration time to a time counter;
comparing the time counter to a predetermined threshold; and
determining whether to continue execution of the second version at the second mobile terminal based on the comparison between the time counter and the predetermined threshold.

12. The method of claim 11, wherein the timer and the time counter are located at the second mobile terminal.

13. The method of claim 11, wherein the timer and the time counter are located at a network server in communication with the second mobile terminal.

14. The method of claim 11, wherein the timer and the time counter are located at the first mobile terminal.

15. The method of claim 1, wherein connecting the first mobile terminal with the second mobile terminal comprises using a network protocol.

16. The method of claim 15, wherein the network protocol is a wireless network protocol.

17. A method of providing shared applications for mobile terminals, the method comprising:
configuring an application for execution on a first mobile terminal;
initiating execution of the application at the first mobile terminal;
connecting the first mobile terminal with a second mobile terminal;
sending a view of the executing application from the first mobile terminal to the second mobile terminal; and
receiving the view of the executing application from the first mobile terminal at the second mobile terminal.

18. The method of claim 17, further comprising:
initiating execution of a controlled application at the second mobile terminal;
displaying the view of the executing application received from the first mobile terminal at the second mobile terminal;
creating control information from the executing controlled application at the second mobile terminal;
sending control information for the executing controlled application from the second mobile terminal to the first mobile terminal;
receiving control information for the executing controlled application from the second mobile terminal at the first mobile terminal; and
responding to the control information at the first mobile terminal.

19. The method of claim 18, wherein responding to the control information comprises:
interpreting the control information at the first mobile terminal;
updating the view of the executing application at the first mobile terminal with the interpreted control information;
sending the updated view of the executing application from the first mobile terminal to the second mobile terminal; and
receiving the updated view of the executing application from the first mobile terminal at the second mobile terminal.

20. The method of claim 17, wherein connecting the first mobile terminal with the second mobile terminal comprises using a network protocol.

21. The method of claim 20, wherein the network protocol is a wireless network protocol.

22. A computer program product for providing shared applications for mobile terminals comprising:
computer code configured to:
connect a first mobile terminal to a second mobile terminal;
transfer a second version of the computer code to the second mobile terminal using the connection; and
limit an execution of the second version of the computer code.

23. A computer program product for providing shared applications for mobile terminals comprising:
computer code configured to:
connect a first mobile terminal to a second mobile terminal;
create a view of the application executing at the first mobile terminal;
send the view created from the first mobile terminal to the second mobile terminal;
receive control information from the second mobile terminal; and
respond to the control information received from the second mobile terminal.

24. The computer program product of claim 23, wherein the computer code is further configured to:
interpret the control information received from the second mobile terminal;
update the view of the application executing at the first mobile terminal with the interpreted control information; and
send the updated view from the first mobile terminal to the second mobile terminal.

25. A computer program product for providing shared applications for mobile terminals comprising:
computer code configured to:
connect a first mobile terminal to a second mobile terminal;
receive a view of an application executing at the first mobile terminal;
display the view of the executing application received from the first mobile terminal;
create control information for the executing application at the first mobile terminal; and
send the control information to the first mobile terminal.

26. A system for providing shared applications for mobile terminals, the system comprising:
a first mobile terminal executing an application; and
a second mobile terminal wherein the first mobile terminal connects to the second mobile terminal, transfers a second version of the application to the second mobile terminal, and limits an execution of the second version of the application.

27. A system for providing shared applications for mobile terminals, the system comprising:
a first mobile terminal executing an application that creates a view; and
a second mobile terminal wherein the first mobile terminal connects to the second mobile terminal and sends the view of the application to the second mobile terminal, and further wherein the second mobile terminal receives the view of the application and sends control information for the application to the first mobile terminal.

28. A system according to claim 27 further comprising a server wherein the first mobile terminal connects to the second mobile terminal through the server.

29. A device configured to provide shared applications for mobile terminals operating in a communication network, the device comprising:
a communication interface that connects the device to a second device; and
a processor coupled to the communication interface that executes an application, wherein the communication interface transfers a second version of the application to the second device, and the processor limits an execution of the second version of the application.

30. A device configured to provide shared applications for mobile terminals operating in a communication network, the device comprising:
a communication interface that connects the device to a second device; and
a processor coupled to the communication interface that executes an application, wherein the communication interface transfers a view of the application to the second device and receives control information for the application from the second device, and the processor responds to the control information received from the second device.
